(19) United States
(12) Patent Application Publication
(10) Pub. No.: US 2010/0146830 A1
(43) Pub. Date: Jun. 17, 2010

(54) DRIVE SYSTEM FOR ROTATING PRISM-TYPE DISPLAY BOARDS

(75) Inventor: Gérard Large, Oyonnax (FR)

Correspondence Address: YOUNG & THOMPSON, 209 Madison Street, Suite 500, Alexandria, VA, 22314, US

(73) Assignee: MECATEC, DAGNEUX (FR)

(21) Appl. No.: 12/161,023

(22) PCT Filed: Jan. 30, 2007
(86) PCT No.: PCT/FR2007/000168

§ 371 Date: Jan. 29, 2009

Related U.S. Application Data
(60) Provisional application No. 60/774,679, filed on Feb. 21, 2006.

(30) Foreign Application Priority Data
Jan. 30, 2006 (FR) 0600818

(51) Int. Cl. G09F 11/02

(52) U.S. Cl. 40/473

(57) ABSTRACT

The drive system for rotating prism-type display boards of the present invention comprises a mechanical system (5) consisting of: a vertical spindle guided axially in a vertical direction XX′ in a housing (6) and comprising above the top wall of the crossmember of a frame a dog clutch (9) engaging directly with the corresponding moving part; and a drum (10) with attached pins (12, 13, 14), the drum being housed in the housing (6) and engaging both with the vertical spindle and with a cam (70) of the drive module (7).

This invention relates to a drive system for advertising boards comprising a plurality of prismatic moving elements arranged side by side either vertically or horizontally.

European patent EP 0539308 belonging to the applicant discloses advertising boards comprising a plurality of rotating prisms arranged side by side and rotated through a fraction of a revolution about their longitudinal axis by a drive system.

The drive system comprises:
a drive shaft provided with a plurality of independent modules equal in number to the number of prismatic moving elements to be driven; and
drums connected to the moving elements, each comprising pins distributed at angles of 120° from each other in order to contact the corresponding module and transmit the cyclical rotation to said elements.

The drive system is housed and guided in a metal structure forming the frame of the advertising board, and abnormal wear has been found in the components of the drive system and of the metal frame caused by poor distribution of the vertical loads and of the kinematic system.

It is an object of the present invention to solve these problems by improving the drive system in such a way as to balance the whole of the kinematic system of each prismatic moving element.

The drive system for rotating prism-type display boards according to the present invention comprises a mechanical system that consists of a vertical spindle guided axially in a vertical direction XX′ inside a housing and comprising above the upper wall of the member of a frame a positive clutch meshing directly with the corresponding moving element, and also of a drum having pins housed inside the housing and engaging both with the vertical spindle and with a cam of the drive module.

The drive system according to the present invention comprises a vertical spindle which is connected at one end, above the upper wall of the member of the frame, to a circular disk, on the upper face of which are V-shaped teeth designed to engage with recesses of complementary shape formed in a foot connected to each moving element.

The drive system according to the present invention comprises a vertical spindle which is guided through the ceiling of the housing in a vertical direction XX′ by a guidance bearing housing comprising on the one hand above said ceiling a first ball bearing or the like on which the lower face of the circular disk rests, and on the other hand below said ceiling another ball bearing or the like engaging with a first cylindrical spacer supported axially by the vertical spindle.

The drive system according to the present invention comprises a guidance bearing housing that comprises prolongations perpendicular to the vertical axis XX′ and drilled with holes to allow screws to fix said bearing housing to the outer face of the ceiling of the housing.

The drive system according to the present invention comprises a mechanical system comprising, below the spacer of the vertical spindle, and separated by a functional play (J1), a drum on whose perimeter are three pins oriented at angles of 120° to each other and all in a plane perpendicular to the axis of rotation XX′.

The drive system according to the present invention comprises a vertical spindle that has, below the spacer, a non-cylindrical profile engaging with a complementary passage formed in the center of the drum so that the latter is coupled rotationally to said vertical spindle.

The drive system according to the present invention comprises a mechanical system comprising, below the drum, and separated by a functional play (J2), a second spacer engaging with the vertical spindle and bearing on the inner face of the bottom of the housing.

The drive system according to the present invention comprises a housing, the bottom of which contains a bore into which the free end of the vertical spindle furthest from the circular disk passes.

The following description, which refers to the accompanying drawings given by way of non-limiting example, will explain more clearly the invention, its features, and the advantages which can be procured thereby:

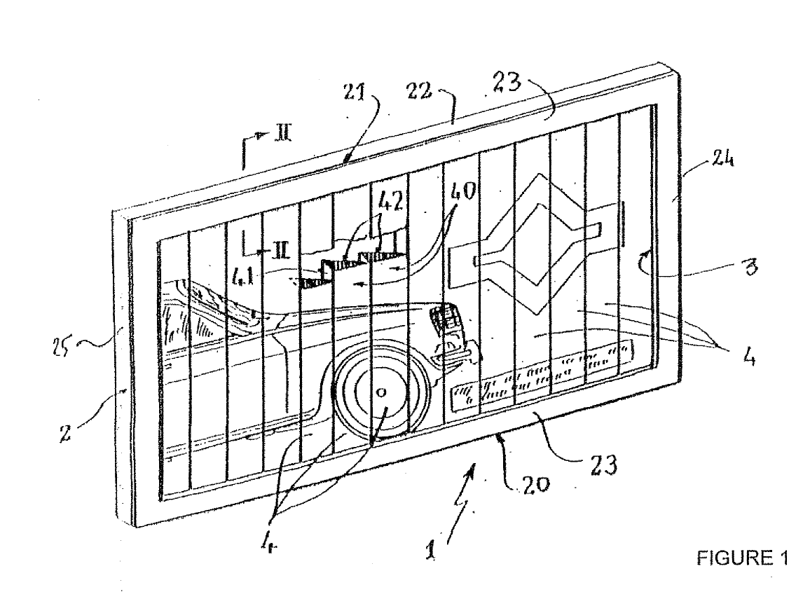

FIG. 1 is a perspective view illustrating an advertising board provided with prismatic moving elements.

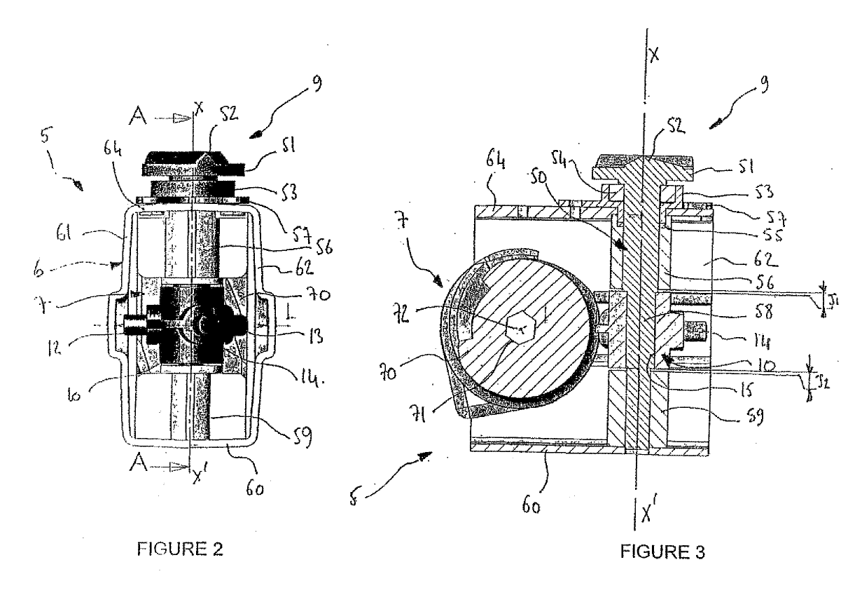

FIG. 2 is a front view showing a drive system for the prismatic moving elements according to the present invention.

FIG. 3 is a cross section taken on A-A as marked in FIG. 2 showing the drive system for the prismatic moving elements according to the present invention.

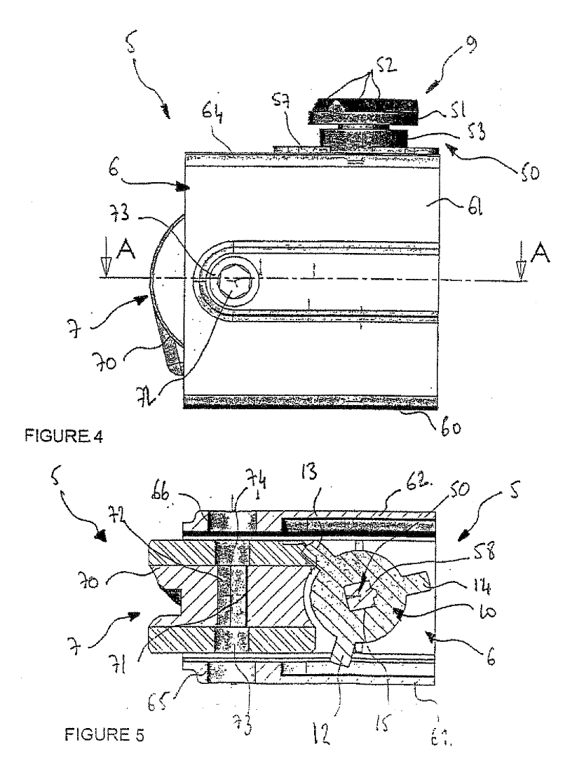

FIG. 4 is a side view showing the drive system for the prismatic moving elements according to the present invention.

FIG. 5 is a cross section taken on A-A as marked in FIG. 4 showing the drive system for the prismatic moving elements according to the present invention.

FIG. 1 shows an advertising board 1 essentially comprising a metal structure or frame 2 comprising a rectangular opening 3 in which are housed a series of prismatic moving elements 4. The moving elements 4 are so positioned that their axis of rotation is oriented either vertically or horizontally.

In the example envisioned, each moving element 4 is presented as having a vertical axis and the profile of its cross section is an equilateral triangle defining three display faces 40, 41, 42.

Each face bears one part of an image which is to be presented to the public simultaneously for a predetermined duration in order to produce, by the combination of all the image parts, a complete advertising image.

For this purpose the moving elements 4 are side by side so as to rotate about their vertical axes in such a way that their respective faces 40, 41 and 42 appear cyclically and at the same time in the same display plane so as to display the complete advertising image.

The metal frame 2 consists of horizontal members 20, 22 connected to vertical members 24, 25 defining the rectangular opening 3 of the advertising board 1.

Each member has a U-shaped profile whose opening 21 is in the same vertical plane as the plane containing the rectangular opening 3 of the advertising board 1. This opening 21 is closed by a removable plate 23.

Inside the horizontal member 20 there is housed and guided, for each moving element 4, a mechanical system 5 engaging with modules 7 arranged in such a way as to form a wheel and worm drive system.

FIGS. 2-5 show a mechanical system 5 and its module 7 for turning a prismatic moving element 4.

In the drive system, for each prismatic moving element 4 there is one mechanical system 5 and module 7.

For each moving element 4 the drive system comprises a housing 6 containing a mechanical system 5 and a module 7, and above said housing a foot 8 connected to said element.

The housing 6 consists of a bottom 60 from which there extend vertically two parallel side walls 61, 62 connected at the opposite end from the bottom 60 to a ceiling 64 fixed underneath the upper wall 26 of the member 20.

At right angles to the side walls 61, 62, the housing 6 comprises openings 63 to allow the mechanical system 5 and its module 7 to be inserted into said housing.

The mechanical system 5 comprises a vertical spindle 50 connected at one end to a circular disk 51 on whose upper face are V-shaped teeth 52 designed to engage with recesses 80 of complementary shape formed in a foot 8, of prismatic profile, which fixes onto the base of each moving element 4.

The teeth 52 and the recesses 80 are distributed around the perimeter of the disk 51 and of the foot 8 to create a positive clutch 9 allowing a single indexing position of the mechanical system 5 to be obtained.

The mechanical system 5 is guided rotationally about its vertical axis XX′ in the housing 6 in such a way that the circular disk 51 of the vertical spindle 50 is above the upper wall 26 of the member 20 so as to engage with the foot 8 of the corresponding prismatic moving element 4.

The vertical spindle 50 is thus guided through the ceiling 64 of the housing 6 in a vertical direction XX′ in a guiding bearing housing 53 comprising on the one hand above said ceiling 64 a first ball bearing or the like 54 on which the lower face of the circular disk 51 rests, and on the other hand below said ceiling 64 another ball bearing or the like 55 engaging with a cylindrical spacer 56 supported axially by the vertical spindle.

The guiding bearing housing 53 comprises prolongations 57 at right angles to the vertical axis XX′ which rest on the outer face of the ceiling 64 of the housing 6 and are drilled to allow fixing screws to be used to fix said bearing housing to said ceiling.

The guidance of the vertical spindle 50 about its vertical axis of rotation XX′ by means of a bearing housing 53 and rolling contact bearings 54, 55, and the position of the positive clutch 9 above the housing 6 results in a kinematic system that supports the vertical loads coming from the prismatic element 4.

Below the spacer 56, the mechanical system 5 comprises a drum 10 or star on whose perimeter are three pins 12, 13 and 14 oriented at angles of 120° to each other and all in a plane perpendicular to the axis of rotation XX′.

Below the spacer 56 the vertical spindle 50 has a non-cylindrical profile 58 engaging with a complementary passage 15 formed in the center of the drum 10 so that the latter is coupled rotationally to said vertical spindle.

As an example, the vertical spindle 50 has a profile 58 which may be splined or of square, hexagonal or other section engaging with a passage 15 of complementary shape through the drum 10.

Below the drum 10, the mechanical system 5 comprises a second spacer 59 engaging with the vertical spindle 50 and resting on the inside face of the bottom 60 of the housing 6. Likewise the bottom 60 of the housing 6 contains a bore into which the free end of the vertical spindle 50 furthest from the circular disk 51 passes.

It will be seen that the mechanical system 5 has a first functional play J1 between the first spacer 56 and the drum 10 and a second functional play J2 between the drum 10 and the second spacer 59 of the vertical spindle 50.

Adjacent to each prismatic moving element 4 and at right angles to the axis of the drum 10 is an independent module 7 designed to form, with the mechanical system 5, a wheel and worm system.

Together, these modules 7 are aligned on a single horizontal axis to form a drive shaft which is turned by a single motor.

Each module 7 essentially comprises a cylindrical cam 70 in the middle of which is a bore 71 which is splined or of square, hexagonal or other section, engaging with the spindle 72 of complementary section.

The spindle 72 is guided in two jaws 73 and 74 of complementary shape, which are themselves retained axially in horizontal bores 65 and 66 formed in the vertical walls 61 and 62 of the housing 6.

The cam 70 of each module 7 is therefore placed between the vertical walls 61 and 62 of the housing 6 in such a way as to engage exactly with the pins 12, 13 and 14 of the drum 10 mounted on the vertical spindle 50 of each mechanical system 5 in order to turn the corresponding moving element 4.

It will be observed that the axial guiding of the cam 70 and drum 10 is provided in the same housing 6, thus eliminating any inaccuracy of perpendicularity between the two axes of rotation.

It will be seen that the splined or hexagonal sleeves 73, 74 of each module 7 make it possible to provide, by means of another spindle of the same profile, not shown, the connection between each adjacent module 7, in such a way as to form the drive shaft of the drive system.

As will be seen, the operation of the mechanical system 5 with its associated module 7, the profile of each cam 70 and the turning of each module is similar to that described in patent EP 0539308 belonging to the applicant.

By means of the combination of components making up the drive system 5, the drive system according to the present invention maintains the mechanical function of the functional plays along the axis of rotation XX′, avoiding premature wear of the latter and of the walls of the member 20.

The drive system according to the present invention repositions the bearing loads of each moving element 4, due to their weight, over the whole of the vertical spindle 50 and avoids wear on the latter and on the mechanical system 5.

The drive system according to the present invention also makes it possible, owing to the position of the positive clutch 9 above the upper face 26 of the member 20, to prevent the positive clutch 9 from coming free of its indexed position when the wind pushes against the corresponding display face 40, 41, 42 of each moving element 4.

Finally, the way in which the components of the drive system 5 are arranged makes it possible to use horizontal members 20 of different dimensions without the risk of deterioration of said system.

it should of course be understood that the above description has been given purely by way of example, that it in no way limits the scope of the invention and that replacing the details of execution described by any other equivalent would not depart from the invention.

1. A drive system for a prismatic moving element (4) of a publicity board (1) comprising, inside a horizontal member (20) forming the frame (2) of said board and adjacent to each moving element (4), a housing (6) containing a mechanical system (5) engaging with a drive module (7), said system being characterized in that the mechanical system (5) consists of a vertical spindle (50) guided axially in a vertical direction XX′ inside the housing (6) and comprising above the upper wall (26) of the member (20) of the frame (2) a positive clutch (9) meshing directly with the corresponding moving element (4), and also of a drum (10) having pins (12, 13, 14) housed inside the housing (6) and engaging both with the vertical spindle (5) and with a cam (70) of the drive module (7).

2. The drive system as claimed in claim 1, characterized in that the vertical spindle (50) is connected at one end, above the upper wall (26) of the member (20) of the frame (2), to a circular disk (51), on the upper face of which are V-shaped teeth (52) designed to engage with recesses (80) of complementary shape formed in a foot (8) connected to each moving element (4).

3. The drive system as claimed in claim 2, characterized in that the vertical spindle (50) is guided through the ceiling (64) of the housing (6) in a vertical direction XX′ by a guidance bearing housing (53) comprising on the one hand above said ceiling (64) a first ball bearing or the like (54) on which the lower face of the circular disk (51) rests, and on the other hand below said ceiling (64) another ball bearing or the like (55) engaging with a first cylindrical spacer (56) supported axially by the vertical spindle (50).

4. The drive system as claimed in claim 3, characterized in that the guidance bearing housing (53) comprises prolongations (57) perpendicular to the vertical axis XX′ and drilled with holes to allow screws to fix said bearing housing to the outer face of the ceiling (64) of the housing (6).

5. The drive system as claimed in claim 3, characterized in that the mechanical system (5) comprises, below the spacer (56) of the vertical spindle (50), and separated by a functional play (31), the drum (10) on whose perimeter are three pins (12, 13 and 14) oriented at angles of 120° to each other and all in a plane perpendicular to the axis of rotation XX′.

6. The drive system as claimed in claim 3, characterized in that the vertical spindle (50) has, below the spacer (56), a non-cylindrical profile (58) engaging with a complementary passage (15) formed in the center of the drum (10) so that the latter is coupled rotationally to said vertical spindle.

7. The drive system as claimed in claim 3, characterized in that the mechanical system (5) comprises, below the drum (10), and separated by a functional play (32), a second spacer (59) engaging with the vertical spindle (50) and bearing on the inner face of the bottom (60) of the housing (6).

8. The drive system as claimed in claim 3, characterized in that the bottom (60) of the housing (6) contains a bore into which the free end of the vertical spindle (50) furthest from the circular disk (51) passes.
